(19) United States
(12) Patent Application Publication
(10) Pub. No.: US 2021/0334307 A1
(43) Pub. Date: Oct. 28, 2021

(54) METHODS AND SYSTEMS FOR GENERATING PICTURE SET FROM VIDEO

(71) Applicant: BOE TECHNOLOGY GROUP CO., LTD., Beijing (CN)

(72) Inventors: Jing YU, Beijing (CN); Lang LIU, Beijing (CN)

(21) Appl. No.: 16/623,347

(22) PCT Filed: May 22, 2019
(86) PCT No.: PCT/CN2019/087965

§ 371 Date: Dec. 16, 2019

(30) Foreign Application Priority Data
Sep. 11, 2018 (CN) 201811055560.1

(51) Int. Cl. G06F 16/738; G06F 16/787; G01C 21/36; G06K 9/00

(52) U.S. Cl. CPC G06F 16/739; G06F 16/787; G06K 2009/00738; G01C 21/3673; G06K 9/00718; G01C 21/3647

(57) ABSTRACT

The present disclosure provides method and systems for generating a preview picture set from a video. The method for generating a preview picture set from the video may include: acquiring a travel route in the video, determining a target location in the travel route, acquiring information of the target location, acquiring an actual picture of the target location, and generating a preview picture set of the video according to the information of the target location and the actual picture. A preview picture set containing video information may be generated to enable a user to conveniently and quickly find the video using the preview picture set, thereby optimizing the user experience.

### TECHNICAL FIELD

The present disclosure relates generally to methods and systems for video processing and generating a preview picture set from a video.

### BACKGROUND

Onboard driving recorders in a vehicle are increasingly used to record road conditions while driving. An on-board recording device may record a large number of driving videos. The videos may be stored in a controller memory of the vehicle or an external server as similarly labeled files. An image from the video such as the first frame of the video may be used as a preview picture for the video.

### SUMMARY

In one example, the issues described above may be addressed by a method for generating a preview picture set from a video, comprising: retrieving a route of travel captured in the video, determining a target location in the travel route, acquiring information of the target location, retrieving an actual captured image of the target location in the video, and generating the preview picture set of the video based on the information of the target location and the actual captured image.

As an example, a route of travel of a vehicle may be determined based on a video captured during travel of the vehicle, a target location may be determined in the travel route; information of the target location and an actual picture of the target location as captured in the video may be acquired, and a preview picture set of the video may be generated based on the information of the target location and the actual picture. The generated preview picture set may also be animated. During the recording of the video, the location information of the passing area is acquired (such as via global positioning satellite) and recorded in real time, and the route of travel of the vehicle is determined according to the location information of the passing area. The location information may include at least one of the following: a location name, an address, a latitude and longitude, and a P.O. Box number. In one example, determining the target location in the travel route may include: obtaining one or more locations of interest of the user, and selecting a place of interest within the travel route from the one or more locations of interest as the target location. In another example, determining the target location in the travel route may include: obtaining a category of interest of the user, and selecting a first location (within the route) as the target location if the first location belongs to the category of interest. In yet another example, the target location in the travel route may include the location where a change in vehicle operating circumstances occurs. The change in vehicle operating circumstances includes at least one of the following: the vehicle colliding, the door of the vehicle being opened, and passengers of the vehicle changing. The target location in the travel route may be determined based on information provided by an external server wirelessly coupled to the vehicle control system. The information of the target location includes at least one of the following: name of target location, address of the target location, latitude, and longitude of the target location, P.O. Box number of the target location.

The vehicle control system may include an apparatus for generating the preview picture set from the video, the apparatus including: an acquiring module configured to determine the travel route in the video, a processor configured to determine a target location in the travel route, and a generator configured to acquire information of the target location and an actual captured image of the target location in the video, and generate a preview photo set of the video according to the information of the target location and the actual captured image. The generating module may also be configured to animate the generated set of preview pictures.

The acquiring module is configured to acquire and record location information of a passing area in real time during the recording process of the video, and determine the traveling route according to location information of the passing area. The processor includes: a first acquiring unit, configured to acquire a plurality of places of interest of a user, a first processing unit configured to select a place of interest from the plurality of places of interest that matches the travel route as the target location. The processor may also include a second acquiring unit configured to acquire a content category of interest of the user, a second processing unit configured to select a transit location (within the route) as the target location if the transit location belongs to the category of interest and a search frequency of the transit location is higher than a threshold number. The processor may further include: a third processing unit configured to determine a target location where a change in vehicle operating circumstances occurs.

Embodiments of the present disclosure also provide an electronic device including a memory, a processor, and a computer program stored on the memory and operable on the processor, the processor executing the program to implement one of the methods described herein. In one example, the electronic device may be a control system of a vehicle, and the memory may include a non-transitory memory such as a non-transitory computer-readable medium. Each of the acquiring module, the processor, and the generator may be part of the electronic device. The embodiment of the present disclosure further provides a user equipment, including the foregoing electronic device, a video acquisition device, and a location information acquisition device, where the electronic device is coupled to the video acquisition device and the location information acquisition device. Optionally, a communication device coupled to the electronic device is further included. A user is defined as a person operating one or more of the vehicle, the video recording device, and a user end device (such as an on-board user interface, a mobile phone, a laptop) from where the travel videos with customized preview pictures may be accessed.

### BRIEF DESCRIPTION OF THE DRAWINGS

FIG. 1 shows a structural block diagram of an apparatus for generating a preview picture set from a video according to an embodiment of the present disclosure.

FIG. 2 is a schematic flow chart of a method for generating a preview picture set from a video according to an embodiment of the present disclosure.

FIG. 3 is a schematic flowchart of obtaining a place of interest from a server according to an embodiment of the present disclosure.

FIG. 4 shows a first part of a schematic flow chart of a first method for generating a video preview animation according to an embodiment of the present disclosure.

FIG. 5 shows a second part of a schematic flow chart of a first method for generating a video preview animation according to an embodiment of the present disclosure.

FIG. 6 shows a first part of a schematic flow chart of a second method for generating a video preview animation according to an embodiment of the present disclosure.

FIG. 7 shows a second part of a schematic flow chart of a second method for generating a video preview animation according to an embodiment of the present disclosure.

### DETAILED DESCRIPTION

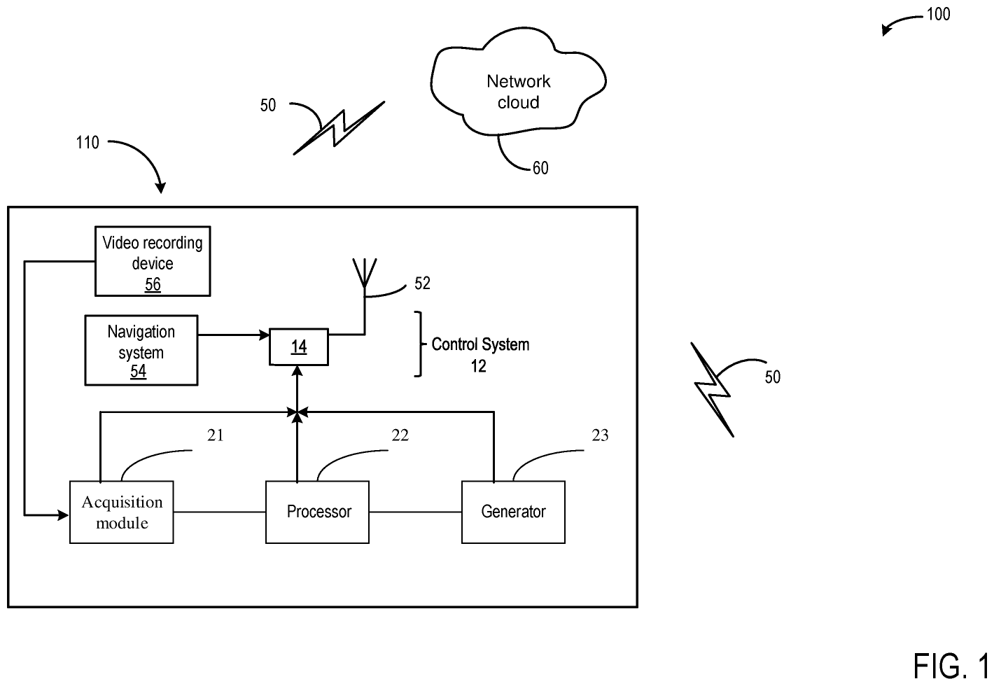

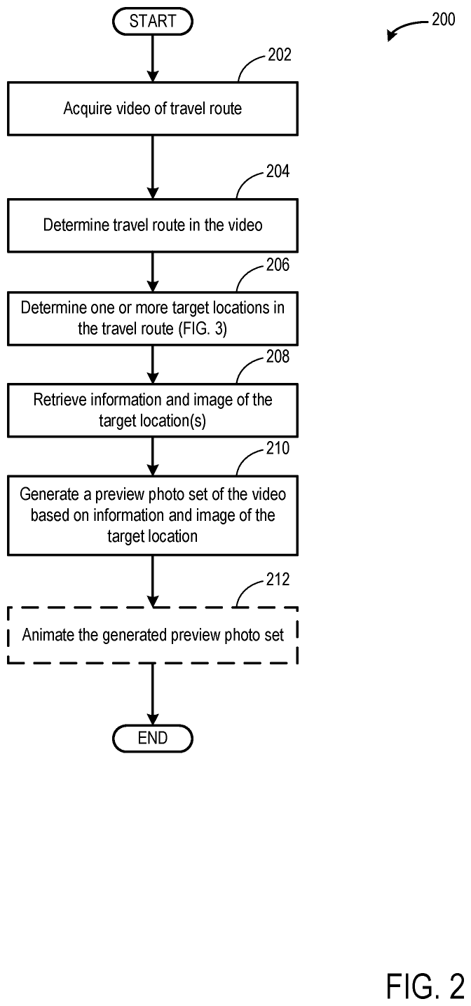

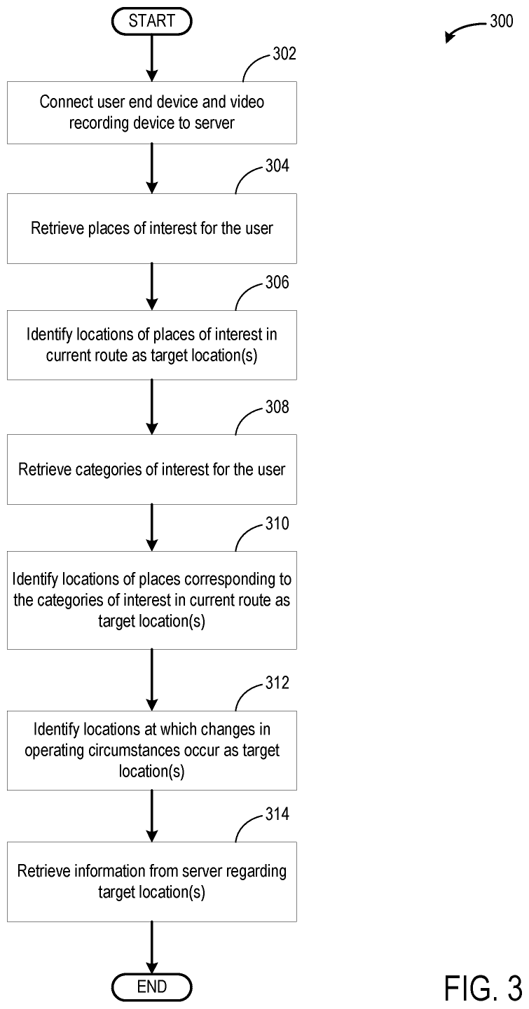

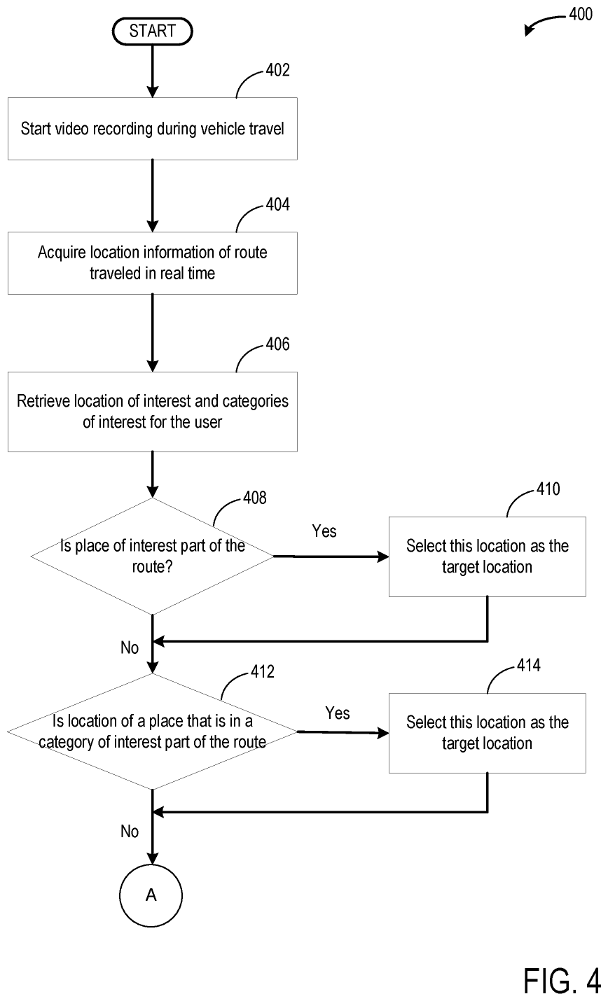

The following description relates to systems and methods for generating a preview picture set for a video recorded via an on-board video recording device of a vehicle. FIG. 1 shows a vehicle system including a video recording device and a control system communicatively coupled to modules for generating a preview picture set for each recorded video. An engine controller may be configured to perform a routine, such as the example routine of FIG. 2 to generate the preview picture set. FIG. 3 shows an example routine for determining places of interest in each recorded video. Example generation of preview video sets for recorded videos are shown in FIGS. 4-7.

In related art, a default method of generating a video preview is to select a certain frame in the video, usually the first frame of the video. The video taken by the video recording device may mostly show the road and the driven vehicle. The video preview generated by this method may only contain road and vehicle information. However, due to similar preview pictures, it might be challenging for a user to select a desired video file from a plurality of video files each marked with a similar preview picture. As such, in order to select the desired video, the user may need to individually click on multiple files before finding the desired one making the process time consuming and computationally intensive. Users may be unable to find the video they need quickly and easily, which adds time and complexity for users to browse videos. Also, each video needs to be available for the user to be accessed before a desired video is identified which makes the process of finding a desired video computationally intensive. In the present disclosure, non-limiting examples of a video recording device may include one or more of a body mounted camera, a camera/imaging device held by (or attached/mounted to) a user who is walking, riding a bicycle riding, or riding a bus or a boat, and other motion cameras used to capture videos of a user or a vehicle while in motion. Video recording device may also include a front camera or a body mounted depth camera of an unmanned (such as autonomous) vehicle and cameras mounted on drones (used for aerial photography). As examples, motion cameras may include a GoPro™ camera and a HTC RE Camera™, and a drone camera may include a camera mounted on a DJI™ drone. Furthermore, the preview picture set may be generated from any video recording capturing motion.

In an embodiment of the present disclosure, the acquisition of location information may be carried out by a location information acquisition device. For example, the motor vehicle may acquire position information during traveling, such as through a navigation system and the acquired position information may be embedded in the video recorded by the on-board video recording device. The motor vehicle may also obtain the position information via the video recording device coupled to a positioning system module such as global positioning system (GPS™), Galileo™ navigation satellite system, BeiDou™ navigation satellite system, and other satellite based navigation systems. In this way, a video embedded with position information may be obtained. A motor vehicle may acquire the driving record video through a smart in-vehicle imaging device connected to a portable (user end) device. Also, location information may be acquired and embedded to the driving record video through the portable device such as a mobile phone, a handheld navigation device, or the like. For example, walking, cycling, bus/train/ship rides, and other locomotion methods, may be captured by a motion camera with a positioning function, or by using a camera of a mobile phone. In this way, as elaborated in the above-described examples, the manner in which the video having the location information is obtained in the embodiment of the present disclosure are diverse, and do not constitute a specific limitation.

In the embodiment of the present disclosure, a name of location (place) refers to the name of the geographical location or a landmark building located at that location, such as Tiananmen Square, the White House, the Eiffel Tower, and other geographical locations or landmarks. An address of the location refers to the country, the province, the city or the village, the street name, house number, building, and other address information, or the number of floors, room number, and other intrabuilding location information, (such as No. 12, Xihuan Middle Road, Daxing District, Beijing, China) of the location. Latitude and longitude of the location refers to the representation of the address in the coordinate (geographic) system (such as latitude 39.9072014648, east longitude 116.1902475357). A postal box number refers to the number of the mailbox set in the postal system, such as P.O. Box 405, white house, NJ 08888.

In order to at least partially solve the problems in the related art, embodiments of the present disclosure provide a method, an apparatus, an electronic device, and a user end device for generating a preview picture set from a video. In this way, the preview picture set, which may be an animation may contain more video information (formed by a photo collection) thereby enabling users to quickly and easily find the video they need and optimize the user experience.

In this way, by customizing each video with a preview animation or thumbnail image including information and image of relevant locations or events as recorded in the video, ease of finding a desired video may be improved. By selecting the relevant locations (also referred herein as target locations) based on the users' preferences, videos containing footage of places of interest may be marked accordingly and can be found easily. The technical effect of assigning customized preview information to each video is that during search for a specific video by a user, processing time and processor power required for browsing and finding the specific video is reduced. Also image processing during the video search is reduced, thereby further accelerating the process and improving user experience.

FIG. 1 shows an embodiment 100 of an apparatus for generating a preview picture set from a video. An example embodiment 100 of a system 110 is shown in communication with an external network (cloud) 60. A vehicle control system 12 may include a controller 14. In this example embodiment, the system 110 is a vehicle. Control system 12 may receive information from a plurality of sensors and send control signals to a plurality of actuators. Based on signals received from the different sensors, the engine operations are regulated and consequently the controller sends control signals to engine actuators. The controller 12 may be a microcomputer, including a microprocessor unit, input/output ports, an electronic storage medium for executable programs and calibration values such as a read only memory chip, random access memory, keep alive memory, and a data bus.

A navigation system 54 may be coupled to the control system 12 to determine a real-time location of the vehicle 110 at any other instant of time (such as during vehicle travel) via a GPS™ system. At a vehicle key-off, the last location (e.g., GPS™ co-ordinates of the vehicle) of the vehicle 110 as estimated by the navigation system 54 may be stored by the control system 12 for use during the next key-on event. The navigation system may be connected to an external server and/or network cloud 60 via wireless communication 50. The navigation system 54 may determine the current location of the vehicle 110 from a network cloud 60. The controller 114 may be coupled to a wireless communication device 52 for direct communication of the vehicle 110 with a network cloud 60. Using the wireless communication device 52, the controller 14 may retrieve user preferences (places of interest, categories of interest, and search history) from the network cloud 60 for use during generation of a preview image/thumbnail of a video recorded via an on-board video recording device 56. Details of the preview image/thumbnail generation method is described in relation to FIG. 3.

The video recording device 56 may include one or more cameras mounted on the body of the vehicle, the camera(s) positioned to capture footage from the street and the surrounding areas through which the vehicle travels. In one example, the camera(s) may capture images of facades of buildings, monuments, tourist attraction, restaurants, parks, stadiums, and other properties. The camera(s) may also capture on-road conditions and traffic conditions (such as other on-road vehicles and traffic signals) along the road on which the vehicle is travelling. The video recording device 56 may also include one or more cameras coupled to the vehicle cabin to capture footage from inside the vehicle cabin including events when a passenger is entering or exiting the vehicle. The captured video (media files) may be stored in the memory of the controller 14 and/or saved in the network cloud 60. As an example, the video files may be periodically transferred to the network cloud 60 for backup.

The videos recorded by the video recording device may be accessed via a user end device which may be inside or outside the vehicle. The user end device may include a human machine interface (HMI) which is communicatively coupled to the network cloud 60 via wireless communication 50. In one example, the user end device may be a mobile phone, a laptop, a tablet, and other interactive electronic devices. In another example, the user end device may be a HMI coupled to the vehicle dashboard. Further, the video recording device 56 and/or the navigation system 54 may be a part of a user end device which may be directly coupled to the controller 14. In one example, the user end device may be used to initiate/terminate video recording during vehicle travel via the video recording device. In one example embodiment, the system 110 (such as a smart phone) may include each of the video recording device 56, the navigation system 54, and user end device.

An acquisition module 21, a processor 22, and a generator 23 may be communicatively coupled to the controller 14 for acquiring a video, processing the video, and generating a preview picture set/thumbnail for the video. In one example, each module may have separate microprocessor units and memory units. In another example, each of the three modules 21, 22, 23 may share a microprocessor unit and a memory unit. In yet another example each of the three modules 21, 22, 23 may operate based on the microprocessor unit and the memory units of the controller 14.

The acquisition module 21 may be configured to acquire a travel route in the video, a processor 22 may be configured to determine a target location in the travel route; and the generator 23 may be configured to acquire information of the target location and an actual captured image of the target location in the video, and generate a preview picture set of the video according to the information of the target location and the actual captured image.

In this embodiment, the preview picture set of the video is generated according to the information of the target location in the travel route and the actual captured image, wherein the target location is an iconic place of interest of the user in the travel route. The technical effect of the present disclosure is that due to inclusion of relevant information in the preview picture set, users can recall the content of the video, which enables users to know more about the video which is convenient for users when they browse the video files so that they can quickly find the video they need, thereby optimizing the user experience. In this way, by customizing the preview picture of each video, search for a desired video may be improved.

In one embodiment, the acquisition module 21 may be configured to acquire and record location information of a passing location in real time during recording of the video, and determine a traveling route of the video according to location information of the passing location.

In one embodiment, the processor 22 may include: a first acquisition unit, configured to acquire a plurality of places of interest of a user of the user end device that is used to access the videos or operate the video recording device, a first processing unit configured to select a location from a plurality of interest locations that is within the travel route as the target location. The processor 22 may include a second acquisition unit configured to acquire a content category of interest of a user of the user equipment, a second processing unit configured to use a transit location as the target location when the transit location within the travel route belongs to the content category of interest and the transit location satisfies a selected condition. The processor 22 may include a third processing unit configured to use, as the target location, a location where a change in vehicle operating circumstances occurs during travel. In one embodiment, the generator may be further configured to animate the generated set of pictures (for preview).

Embodiments of the present disclosure also provide a non-transitory computer readable storage medium having stored thereon a computer program that, when executed by a processor, implements one or more of the steps described above. Optionally, an embodiment of the present disclosure further provides an electronic device, including a memory, a processor, and a computer program stored on the memory and operable on the processor. When the processor executes the program, the following steps may be performed: acquiring a travel route in the video; determining a target location in the travel route; acquiring information of the target location and an actual captured picture of target location in the video, generating a preview picture set of the video according to the information of the target location and the actual captured picture.

Optionally, when the processor executes the program, the following steps may also be implemented: in the recording process of the video, acquiring and recording location information of a passing location in real time, and adjusting progressing of the video according to location information of the passing location route. Optionally, when the processor executes the program, the following steps may be further performed: acquiring a plurality of places of interest of the user of the user end device; and selecting, from the plurality of places of interest, the paces of interest that match the travel route as the target locations.

Optionally, when the processor executes the program, the following steps may be further performed: acquiring a content category of interest of a user of the user end device; searching for a location (passing) along the traveling route that belongs to the content category of interest. When a selection condition is met (such as the location being in the top five most searched location by the user), the passing location is taken as the target location.

Optionally, when the processor executes the program, the following step may be further implemented: using, as the target location, a location where a change in vehicle operating circumstances during the travel is detected by the video recording device and/or the user end device. Optionally, when the processor executes the program, the following steps may be further implemented: the generated preview picture set is animated.

The embodiment of the present disclosure may further provide a user equipment, including the foregoing electronic device, and a video acquisition device, and a location information acquisition device, where the electronic device is coupled to the video recording device and the location information acquisition device. Optionally, a communication device (such as wireless communication device 52) coupled to the electronic device may further be included. Through the communication device, the client device can exchange information with a server (such as the network cloud 60).

It will be appreciated that the embodiments described herein may be implemented in hardware, software, firmware, middleware, microcode, or a combination thereof. For hardware implementation, the processor may be implemented in one or more Application Specific Integrated Circuits (ASICs), Digital Signal Processing (DSP), Digital Signal Processing Equipment (DSP Device, DSPD), programmable Programmable Logic Device (PLD), Field-Programmable Gate Array (FPGA), Universal Central Processing Unit (CPU), Microcontroller (MCU), and other processing units having data processing capabilities and/or program execution capabilities of a logic operation device.

For a software implementation, the techniques described herein can be implemented by modules (e.g., procedures, functions, and so on) that perform the functions described herein. The software code may be stored in memory including non-transitory memory and executed by the processor. The memory may be integrated in the processor or external to the processor.

In the present disclosure, in order to facilitate understanding and description, in some paragraphs, the description of the functions utilizes descriptions such as function unit and function module that are corresponding to the function to be executed by the processor. As used herein, the functions are function entities, which are not necessarily corresponding to any physically or logically independent entities.

The processor may implement these functional entities in the form of executing software in the form of computer instructions, or programmatically implement the functional entities in one or more hardware modules or integrated circuits.

In the present disclosure, the memory may be, for example, a volatile memory and/or a non-volatile memory. The volatile memory may include, for example, a random access memory (RAM) and/or a cache or the like. The nonvolatile memory may include, for example, a read only memory (ROM), a hard disk, a flash memory, or the like.

In the present disclosure, the coupling (amongst one or more of the acquisition module, the processor, the generator, the controller, the video recording device, the user end device, and the network cloud) may be through a network connection, such as a wireless network, a wired network, and/or any combination of a wireless network and a wired network. The network may include a local area network, the internet, a telecommunications network, an internet of things based Internet, telecommunications network, and/or any combination of the above networks, and the like. The wired network can communicate by, for example, twisted pair, coaxial cable, or optical fiber transmission. For example, the wireless network can use a 3G/4G/5G mobile communication network, Bluetooth™ technology, Zigbee™ technology, or Wi-Fi™ technology.

In the present disclosure, the communication device may include a wireless communication network module, such as a wireless communication network module supporting at least one communication mode of GPRS (General Packet Radio Services), EDGE (Enhanced Data for Global Evolution), CDMA (Code-Division Multiple Access) 1×, EVDO (Evolution-Data Optimized), WCDMA (Wideband Code Division Multiple Access), TD LTE (Time Division Long Term Evolution), FDD LTE (Time Division Duplex Long Term Evolution), WiMAX (Worldwide Interoperability for Microwave Access), PHS (Personal Handy-phone System), and other communication modes.

The embodiments of the disclosed embodiments may be provided as a method, apparatus, or computer program product. Thus, embodiments of the present disclosure may take the form of an entirely hardware embodiment, an entirely software embodiment, or a combination of software and hardware aspects. Moreover, embodiments of the present disclosure may take the form of a computer program product embodied on one or more computer usable storage media having computer usable program code embodied therein.

Embodiments of the present disclosure are described with reference to flowchart illustrations and/or block diagrams of methods, user devices (systems), and computer program products according to embodiments of the present disclosure. It will be understood that in each flow and/or block of the flowchart illustrations and/or figures. The computer program instructions may be provided to a general purpose computer, a special purpose computer, an embedded processor, or other programmable data processing user device processor to generate a machine such that instructions are executed by a processor of a computer or other programmable data processing user device. Means are provided for implementing the functions specified in one or more of the flow or in a block or blocks of a flow diagram.

The computer program instructions can also be stored in a non-transitory computer readable memory that can direct a computer or other programmable data processing user device to operate in a particular manner, such that the instructions stored in the computer readable memory produce an article of manufacture comprising the instruction device. The instruction device implements the functions specified in one or more blocks of the flow or in a flow or block diagram of the flowchart.

These computer program instructions can also be loaded onto a computer or other programmable data processing user device such that a series of operational steps are performed on the computer or other programmable user device to produce computer-implemented processing. The instructions discussed above provide steps for implementing the functions specified in one or more blocks of the flowchart or in a block or blocks of the flowchart.

Turning to FIG. 2, routine 200 depicts a method for generating a preview picture set from a video. Instructions for carrying out method 200 and the rest of the methods included herein may be executed by controller 14 based on instructions stored on memory of the controller and in conjunction with each of an acquisition module, a processor, and a generator as described above with reference to FIG. 1.

At 202, video of the travel route may be acquired via one or more video recording devices (such as video recording device 56 in FIG. 1). In one example, the video recording devices may be mounted external to a vehicle and within a vehicle cabin. In one example, the video recording devices may start acquiring video at an onset of each drive cycle. In another example, a user (such as driver/passenger of the vehicle) may physically or remotely activate (such as via a switch of a user end device) the video recording devices. Video of the travel route may include footage of the road, the traffic condition (on-road vehicles, traffic signals, congestion, and other traffic situations), surrounding landmarks (monuments, buildings, tourist attractions, parks, stadiums, etc.), surrounding businesses (restaurants, cafes, shopping malls, offices, and other establishments).

As an example, if the video is recorded by a video recording device that is carried by a pedestrian or mounted on a bike, video of walking paths, sidewalks, bicycle paths, pedestrian traffic, crosswalks, hiking path, and scenery may be recoded. If the video is recorded by a video recording device that is carried by a boat passenger, video of waterways, other on-water vessels, and marine life may be recorded.

At 204, the travel route may be determined based on input from a navigation system (such as navigation system 54 in FIG. 1). For example, position information may be acquired during traveling, such as through the navigation system and the acquired position information may be embedded in the video recorded by the on-board video recording device. Each frame captured in the video may include geoposition (such as latitude, longitude) of the location.

In this way, during the recording of the video, the location information of the passing area is acquired and recorded in real time, and the traveling route in the video is determined according to the location information of the passing area. The location information may include at least one of the following: a place name, an address, a latitude and longitude, and a P.O. Box number.

At 206, one or more target locations in the travel route may be determined. Determining the target location in the travel route may comprise: obtaining multiple places of interest (POI) of the user of the user end device, selecting a place of interest within the travel route from the plurality of POIs as the target location. In some embodiments, the user may enter or select a plurality of POIs from a map database in the user end device. For example, for a user end device with a touch screen, the user may select multiple POIs by clicking or virtual keyboard input. For example, for a user end device with a physical keyboard, the user may select multiple POIs by inputs via the keyboard. For example, for a user end device that can communicate with a computer on which a hypervisor corresponding to the user end device is installed, the user can select multiple POIs on the computer.

In some embodiments, a plurality of places of interest (POIs) of the user of the user end device may be obtained from a server device (such as by way of the network cloud 60 in FIG. 1). In one example, the server device may be a server shared by multiple user end devices, and multiple interest points may be provided in a distinguishable manner such as based on a user end device ID and a user account of the user device. In another example, the server device may be distinct for a particular user. In another example, the server device may include a private server that may provide multiple places of interest for the corresponding associated user end device. As an example, the private server-side device may be a physical server (such as a server located in a data center computer room), or may be a virtual server built on a cloud-based service (such as Amazon Wed Services, Azure, and other cloud based services). Details of the determination of the one or more target locations is discussed in relation to FIG. 3.

At 208, information of the target location and an actual captured image of the target location in the video may be retrieved from the video recording. In one example, the information of the target location may include one or more of the location name, address, latitude and longitude, target location category (shops, restaurants, tourist attractions, and other categories of interest) and other relevant information. In one example, as described previously, this information regarding the target location (and each frame of the video) may be embedded in the video recording. In another example, the geoposition (latitude and longitude) information regarding the target location may be embedded in the video and other information such as name, address, category, and other information corresponding to the geoposition may be obtained from the server. The actual captured image of the location may be a frame from the captured video corresponding to the geoposition of the target location.

At 210, a preview photo set of the video may be generated based on the information of the target location and the actual captured image. In one example, information of the target location (such as address, name, geolocation, and other characteristics identifying the location) may be included as text with the actual captured image in the preview photo set. The text may be displayed on the actual captured images.

In this way, the preview picture set of the video is generated according to the information of the target location in the travel route and the actual shooting picture, where the target location is a place of interest along the traveling route.

Through the technical solution of the present disclosure, a picture set containing more video information may be generated, which is convenient for the user to recall the content of the video and the related details. In this way, the user may learn more information about the video which then facilitates the user in browsing and selecting a video file of interest within a short time, thereby optimizing the user experience.

In some embodiments, the method further comprises the step 212 of animating the generated set of pictures. The animation may include images of the target locations and text providing details of the target locations. For example, the format of the animation may be GIF (Graphics Interchange Format), FLV (Flash Video), APNG (Animated PNG), MNG (Multiple-image Network Graphics), SVG (Scalable Vector Graphics), and other digital animation formats. For example, the format of the animation may appear in the form of a preview video, and the multi-frame picture may be encoded and packaged into the main video in a video encoding format such as MPEG2 (Moving Picture Experts Group 2), MPEG4 (Moving Picture Experts Group 4), DIVX™, and VP9™.

The numbering (sequence) of the above steps is merely illustrative, and does not limit the order of steps.

FIG. 3 shows an example routine 300 for determining a target location captured in a video recorded during vehicle motion. A user's place of interest may be determined based on interaction of a processor (such as processor 22 in FIG. 1) coupled to a controller and a server (such as by way of network cloud 60 in FIG. 1) connected to a user end device and/or the video recording device.

At 302, the user end device and the video recording device may be connected to the server. In one example, the user may connect to the server by logging on to a user account. In another example, the user end device may be automatically logged onto the server at the onset of a drive cycle. The user end device may include a mobile phone, computer, and other electronic devices, and the video recording device may include one or more cameras mounted on the vehicle (external to the vehicle body and within the vehicle cabin). In one example, the user end device may be used as the video recording device.

At 304, places of interest for the user may be retrieved from the server. A location that the user frequently searches for and/or visits may be marked as a place of interest. The server may communicate with the user end device, and the server may obtain one or more locations (destinations) that the user frequently goes to or the location that is frequently followed and searched in the server or in an offline/online resource such as a map, and marks the location as a place of interest. In one example, if a location is searched for by the user more than a first threshold number of times, the location may be marked as a place of interest. As an example, if a user has searched for a library more than five times, the library may be marked as place of interest for the user. In another example, if the user visits a location more than a second threshold number of times, the location may be marked as a place of interest. As an example, if a user has visited a tourist attraction more than three times, the tourist attraction may be marked as place of interest for the user. In this way, a selection criteria may be enforced to identify one or more locations as a user's place of interest.

At 306, one or more places of interest as retrieved in step 304 that are in the current route of travel may be identified as target location(s). As an example, ten points of interest may be retrieved form the server and one out of the ten points of interest may be identified to be located in the route of travel of the vehicle. Hence an image of that one place of interest may be captured in the video recorded during travel of the vehicle along the route.

At 308, a category of interest of the user end device may be retrieved from the server. The server may communicate with the user end device, and the server may obtain one or more categories of places that the user frequently goes to or the category that is frequently searched in the server or in an offline/online resource such as a map, and mark the categories as a place of interest. In one example, if a category is searched for by the user more than a third threshold number of times, the location may be marked as a category of interest. As an example, if a user has searched for a restaurant more than ten times in the past, restaurants may be marked as category of interest for the user. As an example, the first threshold, the second threshold, and the third threshold may be same or distinct positive integer numbers.

As an example, a category may be set to as a popular category (category of interest) if a frequency at which the user or multiple users search for the category is higher than a threshold frequency. For example, the search popularity may be set to an online map, such as Google Maps, Microsoft Map, and other maps, and the threshold frequency may be set at once a day. As an example, if a user searches for a cafe more than once a day, cafes may be marked as category of interest for the user.

At 310, one or more locations of places corresponding to categories of interest as retrieved in step 308 that are in the current route of travel may be identified as target location(s). As an example, two categories of interest may be retrieved form the server and two locations corresponding to one or both the retrieved categories of interest may be identified to be located in the route of travel of the vehicle. Hence an image of the two locations may be captured in the video recorded during travel of the vehicle along the route.

At 312, during the travel, one or more locations where a change in operating circumstances occur as determined based on a user equipment may be identified as a target location. For example, the user equipment may include the video recording device or the like mounted on the exterior or inside the cabin of a motor vehicle. A change in vehicle operating circumstance includes at least one of the following: the vehicle collides, a door of the vehicle is opened; and one more passengers of the vehicle changes such as one or more passengers enters or leaves the vehicle at a stop. In an example, the user equipment may be a motion camera carried by the user during walking or cycling, and the change in operating circumstance may include at least one of the following: sudden stop while traveling, quick turns, and other maneuvers. In one example, the change in operating circumstances may be identified based on image processing of the video captured during the travel. In another example, the change in operating circumstances may be identified based on inputs from one or more sensors such as sensors coupled to vehicle doors for monitoring opening/closing of the door.

At 314, information about the target locations may be retrieved from the server. Information such as location name, address, latitude and longitude, and the like about the user's target locations may be obtained through data analysis, information about the target locations may also be directly retrieved from the server. Optionally, in some embodiments, the information of the target location may include at least one of the following: a real picture of the target location, a name of the target location, an address of the target location; the latitude and longitude of the target location, the P.O. Box number of the target location, and other details.

The routine may further include analyzing the target location category. The server side may also analyze the target location category according to the obtained related information of the target location. For example, the category of the target location may be a shopping mall, a restaurant, a tourist attraction, and the like, and the obtained target location category may be marked as the user's category of interest. As an example, a target location may be marked with a category and that category may be saved as the user's category of interest. In one example, if the target location is a café that the user frequents, cafes may be included as a category of interest for the user.

The technical effect of the embodiment of the present disclosure enriches the selection manner of the target location as compared to conventional technologies. Conventional technologies may generate a non-descript preview image for each video making it difficult to identify locations or events recorded in that video. By customizing each preview with relevant images from the video, the videos may be made identifiable. By selecting points of interests (target locations) of the user, the preview picture set may be personalized for the user, thereby improving user experience while searching for a specific video. When a location belongs to the user's category of interest, and the search history of the location satisfies a selected condition, (such as the first few names in the search list), the geographical position of the point is recorded as the target location. If the vehicle collides, the geographical location of the point where the collision takes place is recorded as the target location. If a camera in the vehicle photographs change in circumstance (such as the number of people in the car changes), the geographical location at which the change in circumstance takes place is recorded as the target location.

An example implementation of the method 300 of the embodiment of the present disclosure is further described in conjunction with a specific embodiment. FIG. 4 shows a routine 400 for generating a video preview animation. At 402, video recording via one or more on-board video recording devices may be started. Taking the driving recorder installed on the motor vehicle as the example, the driving recorder may automatically start recording video after the vehicle starts to drive.

At 404, location information related to the route traveled may be acquired and recorded in real time. During the video recording process, the GPS™ module in the navigator, the video recording device, and/or the user end device may acquire and record relevant information of the passing location in real time, such as the name of the place, the address, the latitude and longitude, and other details, and obtain the traveling route of the vehicle as recorded by the video.

At 406, the user's locations of interest and categories of interest may be retrieved from a server. The retrieved locations of interest and categories of interest may then be matched with the travel route to determine if any place of interest or a place that falls in a category of interest is present in the travel route.

The user may log in to the server account through the user end device, and the user end device communicates with the server, obtains the user's places in interest stored on the server, and matches the user's places of interest with the travel route.

At 408, the routine includes determining whether a place of interest is part of the travel route. The result of matching the travel route with the user's locations of interest is used to determine whether the travel route passes through a location corresponding to a POI of the particular user. If it is determined that a place of interest is part of the route, at 410, the passing place of interest is selected as the target location of the video, and the geographical location of the target location is recorded. The routine may then proceed to step 412.

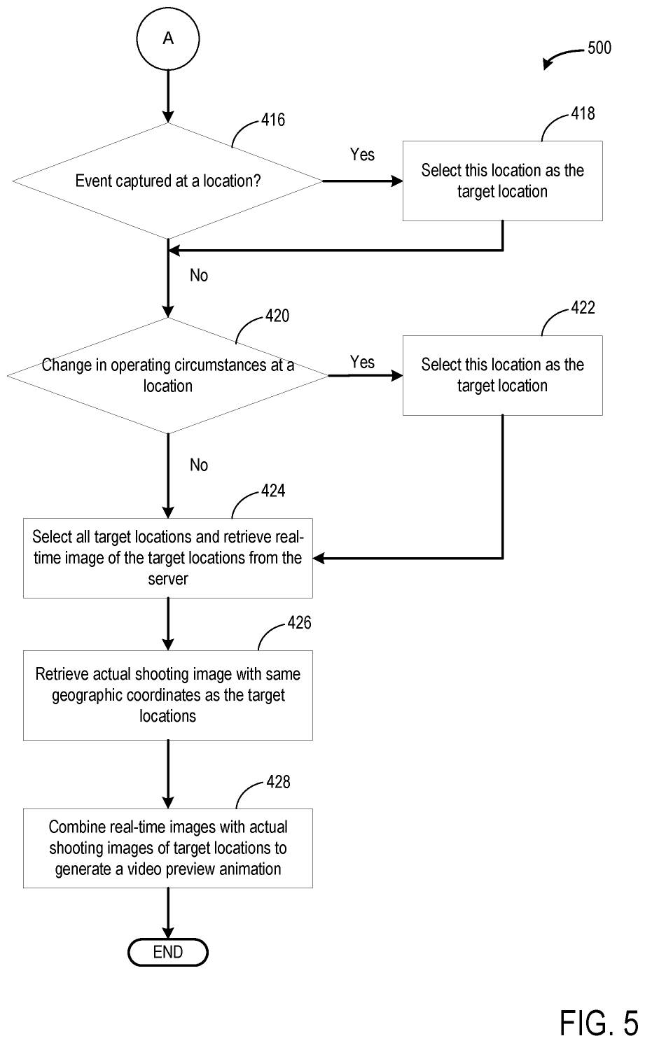

If it is determined that a location of a place of interest is not part of the route, at 412, the routine includes determining whether a location of a place that is in a category of interest part of the travel route. The user end device may communicate with the server to obtain a category of interest for the user stored on the server. As an example, when a location along the travel route belongs to the category of interest of the user, and the search history of the location indicates that the location is positioned at higher than threshold number (N) in the user's search list (list of top search locations), N being a positive integer, the location may be a target location. If it is determined that a location of a place that is in the category of interest is part of the travel route, at 414, the location may be selected as the target location, and the routine may proceed to step 416. The routine 400 continues as routine 500 in FIG. 5.

Moving to FIG. 5, if it is determined that a location of a place that is in a category of interest is not part of the travel route, at step 416, the routine includes determining if an event such as vehicle collision has occurred. The collision may be between the vehicle and one or more vehicles, infrastructure, tree, pedestrian, and/or animal as recorded by the on-board video recording device. An event may also include collision between other on-road vehicles that is captured in the video recording.

If it is determined that an event such as vehicle collision has occurred, at 418, the location where the event occurs is selected as the target location, and the geographical location of the target location is recorded. The routine then proceeds to step 420.

If it is determined that an event has not occurred, at 420, the routine includes determining whether a change in vehicle operating circumstances is captured by the video redounding device (mounted external to the vehicle or within a vehicle cabin).

Other imaging devices may be disposed on the vehicle, and other imaging devices may communicate with the user end device. When the user equipment or other camera equipment captures change in vehicle operating circumstances, such as when the door of the vehicle is opened, or the number of passengers of the vehicle changes, at 422, the location where the change in vehicle operating circumstances is photographed (captured) is selected as the target location, and the geographical location of the target location is recorded. The routine may then proceed to step 424.

At 424, all target locations (as selected in the aforementioned steps) are selected and real-time images of each target location are retrieved from the server. After the target location is selected in the above manner, the user end device may request the real-time images of all the target locations from the server. If a target location does not have a real-time image, a blank image (background) overlay with text (the content of the text may be the location name) may be used instead. As an example, if a frame with a real-time image of a monument (target location) cannot be retrieved, a blank background with the name of the monument may be used instead of the real-time image.

At 426, an actual shooting picture with the same geographical coordinates as that of the target locations may be retrieved from the video. Since the geographic location of the target location has been recorded, the actual captured image with the same geographic coordinates (such as latitude and longitude) of all the target locations can be found in the video corresponding to the geographic location of each target location. As an example, the real-time image may be an image that is not captured in the video but a stock image as found of the target location in the server. The real-time image may be an image of the target location that was previously captured and stored in the memory of the user end device or uploaded to the server. Whereas, the actual shooting image may be a frame from the recorded video that shows the target location.

At 428, each of the real-time images and the actual shooting images may be combined to generate a video preview animation. The real-time images of all the target locations with the actual shot images may be combined as a preview animation or thumbnail of the video.

In this embodiment, a video preview animation of the video is generated according to the information of the target location in the travel route and the actual captured image, wherein the target location is an iconic place of interest in the travel route, and can be generated by the technical solution of the present disclosure. A video preview animation may include more video information which is convenient for the user when recalling the content of the video. The generated preview customized for each video enables the user to know more about the video, facilitating the user to browse the video file and quickly find the video he needs, thereby optimizing user experience and reducing browsing time and computational resources needed during browsing.

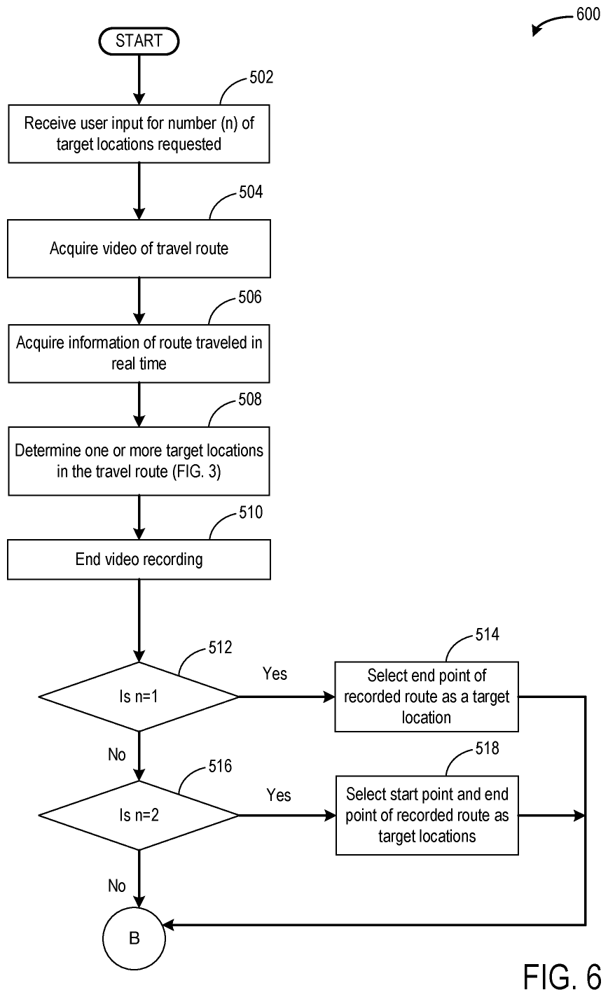

FIG. 6 shows an example routine 600 for generating a video preview animation. At 502, user input may be received indicating a number (n) of target locations requested for the preview photo set of the video. As an example, the user may indicate the input using a user end device with a touch screen, a virtual keyboard input, a physical key board, and other input techniques.

At 504, video of the travel route may be acquired during the drive cycle. Video recording during travel (such as travel by vehicle, bike, boat, walking, and other methods of locomotion) via one or more video recording devices may be initiated. In one example, a user may initiate the video recording via an input to the user end device communicatively coupled to the video recording devices. In another example, the video recording may start upon an onset of a drive or travel cycle.

At 506, information of the route travelled may be acquired and recorded in real time. During the video recording process, the GPS' module in the navigator, the video recording device, and/or the user end device may acquire and record relevant information of the passing location in real time, such as the name of the place, the address, the latitude and longitude, and other details, and obtain the traveling route of the vehicle as recorded by the video.

At 508, one or more target locations (also referred herein as points of interest) may be determined along the travel route. Details of determining target locations are described in relation to FIG. 3. At 510, upon completion of the travel cycle, video recording may end. In one example, a user may end the video recording via an input to the user end device communicatively coupled to the video recording devices. In another example, the video recording may end upon completion of a travel cycle (such as marked by vehicle coming to a stop and the engine being shut down).

At 512, the routine includes determining if the number (n) of target locations to be included in the preview picture set is one. If it is determined that n is selected to be one, at 514, the end point of the recorded route may be selected as the target location. If it is determined that n is not selected to be one, at 516, the routine includes determining if the number (n) of target locations to be included in the preview picture set is two. If it is determined that n is selected to be two, at 518, each of the start point and the end point of the recorded route may be selected as the target locations.

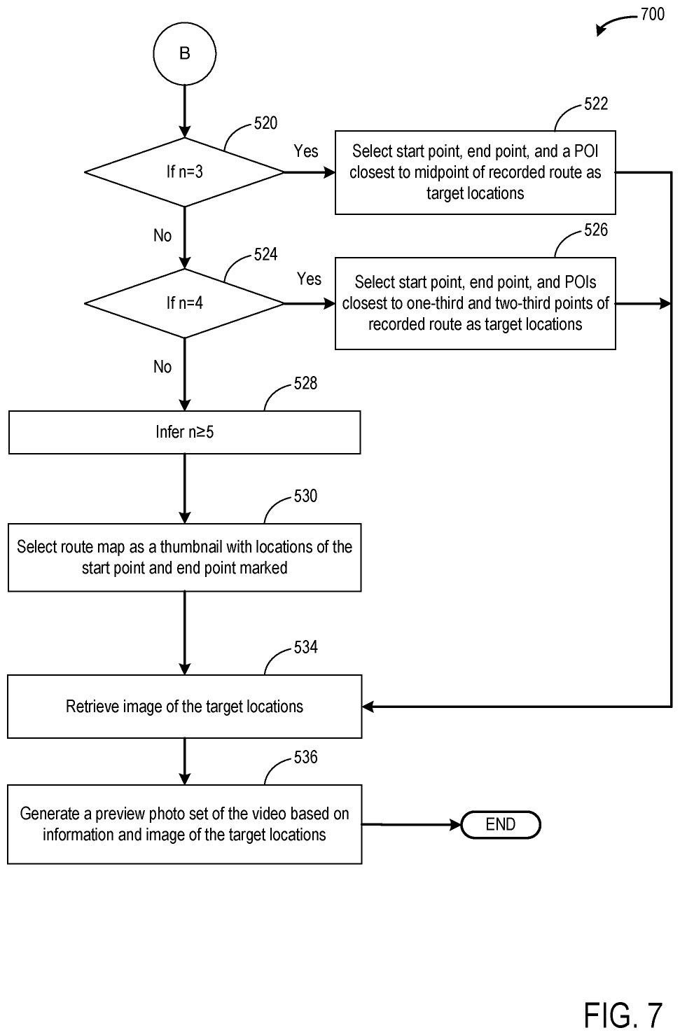

The routine may continue as routine 700 in FIG. 7. If it is determined that n is not selected to be two, at 520, the routine includes determining if the number (n) of target locations to be included in the preview picture set is three. If it is determined that n is selected to be three, at 522, each of the start point, the end point, and a place of interest (POI) closest to the midpoint of the recorded route may be selected as the target locations. As an example, amongst the POIs determined in step 508, the POI which is closest to the midpoint of the travel route may be one of the selected target locations.

If it is determined that n is not selected to be three, at 524, the routine includes determining if the number (n) of target locations to be included in the preview picture set is four. If it is determined that n is selected to be four, at 526, each of the start point, the end point, a first POI closest to the one-third point, and a second POI closest to the two-third point of the recorded route may be selected as the target locations. As an example, amongst the POIs determined in step 508, a POI which is closest to the one-third point of the travel route (distance wise) and a POI which is closest to the two-third point of the travel route (distance wise) may be two of the selected target locations.

If it is determined that n is not selected to be four, at 528, it may be inferred that the number (n) of target locations to be included in the preview picture set is greater than or equal to five. In response to selection of at least five as the number of target locations to be included in the preview picture set, at 530, a route map of the travel route along with locations of the start point and the end point marked on the map may be used as thumbnail for the video. The route map may be generated based on the route information acquired during the travel cycle. As an example, along with the route map, images of one or more target locations may be used in the thumbnail.

At 534, one or more images of the selected target locations may be retrieved from the server. In one example, the images may be frames captured during the video recording. In another example, the images may be previously captured images of the locations as saved in the server. At 536, a preview photoset of the video may be generated based on the information and the images of the target locations. If an image is not available for a target location, a blank frame with text reading the name/address of the target location may be included in the preview photo set. As an example, if a frame with a real-time image of a park (target location) cannot be retrieved, a blank background with the name of the park may be used instead of the real-time image. In one example, information of the target location (such as address, name, geolocation, and other characteristics identifying the location) may be included as text with the actual captured image in the preview photo set. The text may be displayed on the actual captured images.

In this way, by generating a customized preview photo set for each video, future identification of each video may be simplified. Lower time and computation power may be needed during browsing and selecting a certain video. The technical effect of identifying target locations based on user preferences and user search history is that images of such target locations may be easily identifiable by the user during browsing for a certain video. By including footage from events such as collision captured in the video during the travel cycle, videos including information from specific events may be easily retrieved. Overall by including relevant information in the preview photoset/thumbnail of a video, user experience while searching for a desired video may be improved.

An example method for generating a preview picture set from a video comprises: retrieving a travel route captured in the video, determining a target location in the travel route, acquiring information of the target location, retrieving an actual captured image of the target location in the video, and generating the preview picture set of the video based on the information of the target location and the actual captured image. In any preceding example, additionally or optionally, the retrieving the travel route comprises: during recording of the video, acquiring and recording location information of each passing area in real time, and determining the travel route captured in the video based on the location information of each of the passing areas. In any or all of the preceding examples, additionally or optionally, the location information of each passing area includes one or more of a place name, an address, a latitude and longitude, and a P.O. Box number. In any or all of the preceding examples, additionally or optionally, determining the target location in the travel route comprises: retrieving one or more points of interest of a user of a user end device from a server, and selecting a retrieved place of interest matching the travel route as the target location. In any or all of the preceding examples, additionally or optionally, determining the target location in the travel route further comprises: retrieving a category of interest of the user of the user end device from the server, and selecting a transit location as the target location if the transit location in the travel route belongs to the retrieved category of interest and a search history of the transit location satisfies a selection condition. In any or all of the preceding examples, additionally or optionally, determining the target location in the travel route further comprises: selecting a location where an event occurs during travel of a vehicle as the target location. In any or all of the preceding examples, additionally or optionally, the event comprises at least one of collision of the vehicle, an opening of a door of the vehicle, and a change in passenger of the vehicle. In any or all of the preceding examples, additionally or optionally, the information of the target location comprises at least one of a real picture of the target location, a name of the target location, an address of the target location, latitude and longitude of the target location, and a P.O. Box number of the target location. Any or all of the preceding examples, further comprising, additionally or optionally, animating the generated preview picture set.

Another example apparatus for generating a picture set from a video, comprises: an acquisition module configured to obtain a travel route as recorded in a video, a processor configured to determine a target location captured in the route, and a generating module configured to acquire each of an information of the target location and an actual captured image of the target location in the video, and generate a preview photo set of the video based on the information of the target location and the actual captured image. In any preceding example, additionally or optionally, the obtaining module is configured to acquire and record location information of each passing location in real time during recording of the video, and determine the travel route based on the location information of each passing location. In any or all of the preceding examples, additionally or optionally, the processor comprises: a first acquiring unit configured to acquire a plurality of places of interest of a user of a user equipment from a server; a first processing unit configured to select a place of interest from the plurality of places of places of interest that is within the travel route as the target location; a second acquiring unit configured to acquire a content category of interest of the user of the user equipment; a second processing unit configured to use a transit location within the travel route as the target location if the transit location belongs to the acquired content category of interest and a search frequency of the transit location is higher than a threshold number; and a third processing unit configured to use, as the target location, a location where the user equipment encounters a change in vehicle operating circumstance during traveling. In any or all of the preceding examples, the generating module is further configured to animate the preview photo set. In any or all of the preceding examples, each of the acquisition module, the processor, and the generator are part of an electronic device comprising a memory, a processor, and a computer program stored on the memory and operable on the processor, wherein the processor executes the program to implement operations of each of the acquisition module, the processor, and the generator. In any or all of the preceding examples, the user equipment includes one or more of a video acquisition device and a location information acquisition device, the electronic device coupled to each of the video acquisition device, the location information acquisition device, and a communication device.

It will be appreciated that ordinal terms such as “first” and “second” are used merely to distinguish one entity or operation from another entity or operation, and do not necessarily require or imply any such actual relationship or order between these entities or operations.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

It is to be understood that the above embodiments are merely exemplary embodiments employed to explain the principles of the inventive concepts, but the inventive concepts are not limited thereto. Various modifications and improvements can be made by those skilled in the art without departing from the spirit and scope of the disclosure, and such modifications and improvements are also considered to be within the scope of the disclosure.

1. A method for generating a preview picture set from a video, comprising:
retrieving a travel route captured in the video,
determining a target location in the travel route,
acquiring information of the target location; retrieving an actual captured image of the target location in the video; and
generating the preview picture set of the video based on the information of the target location and the actual captured image.

2. The method of claim 1, wherein the retrieving the travel route comprises:
during recording of the video, acquiring and recording location information of each passing area in real time, and determining the travel route captured in the video based on the location information of each of the passing areas.

3. The method of claim 2, wherein the location information of each passing area includes one or more of a place name, an address, a latitude and longitude, and a P.O. Box number.

4. The method of claim 1, wherein determining the target location in the travel route comprises: retrieving one or more points of interest of a user of a user end device and selecting a retrieved place of interest matching the travel route as the target location.

5. The method of claim 1, wherein determining the target location in the travel route further comprises: retrieving a category of interest of a user of a user end device, and selecting a transit location as the target location if the transit location in the travel route belongs to the retrieved category of interest and a search history of the transit location satisfies a selection condition.

6. The method of claim 1, wherein determining the target location in the travel route further comprises: selecting a location where an event occurs during travel of a vehicle as the target location.

7. The method of claim 6, wherein the event comprises at least one of collision of the vehicle, an opening of a door of the vehicle, and a change in passenger of the vehicle.

8. The method of claim 1, wherein the information of the target location comprises at least one of a real picture of the target location, a name of the target location, an address of the target location, latitude and longitude of the target location, and a P.O. Box number of the target location.

9. The method of claim 1, further comprising animating the generated preview picture set.

10. The method of claim 4, wherein determining the target location in the travel route is based on one or more points of interest of a user and/or the category of interest of a user retrieved from a server.

11. An apparatus for generating a picture set from a video, comprising:
an acquisition module configured to obtain a travel route as recorded in a video,
a processor configured to determine a target location captured in the route,
a generator configured to acquire each of an information of the target location and an actual captured image of the target location in the video, and generate a preview photo set of the video based on the information of the target location and the actual captured image.

12. The apparatus of claim 11, wherein the acquisition module is configured to acquire and record location information of each passing location in real time during recording of the video, and determine the travel route based on the location information of each passing location.

13. The apparatus of claim 11, wherein the processor comprises:
a first acquiring unit configured to acquire a plurality of places of interest of a user of a user equipment from a server; and
a first processing unit configured to select a place of interest from the plurality of places of places of interest that is within the travel route as the target location.

14. The apparatus of claim 11, wherein the processor comprises:
a second acquiring unit configured to acquire a content category of interest of a user of a user equipment; and
a second processing unit configured to use a transit location within the travel route as the target location if the transit location belongs to the acquired content category of interest and a search frequency of the transit location is higher than a threshold number.

15. The apparatus of claim 11, wherein the processor comprises: a third processing unit configured to use, as the target location, a location where a user equipment encounters a change in vehicle operating circumstance during traveling.

16. The apparatus of claim 11 wherein the generator is further configured to animate the preview photo set.

17. The apparatus of claim 11, wherein each of the acquisition module, the processor, and the generator are part of an electronic device comprising a memory and a computer program stored on the memory and operable on the processor, wherein the processor executes the program to implement a method, comprising:
retrieving the travel route captured in the video;
determining the target location in the travel route;
acquiring information of the target location;
retrieving an actual captured image of the target location in the video; and
generating the preview picture set of the video based on the information of the target location and the actual captured image.

18. The apparatus of claim 17, wherein the user equipment includes one or more of a video acquisition device and a location information acquisition device, the electronic device coupled to each of the video acquisition device and the location information acquisition device.

19. The apparatus of claim 17, wherein the electronic device is further coupled to a communication device.

20. A method, comprising:
receiving user input for a number of target locations requested;
during recording a video, retrieving location information of each passing area; and
upon completion of the recording of the video:
determining a travel route based on the retrieved location information,
selecting the number of target locations along the travel route,
retrieving one or more images for each of the number of target locations, and
generating a preview picture for the video including the one or more images.
